(19) United States
(12) Patent Application Publication
(10) Pub. No.: US 2026/0119482 A1
(43) Pub. Date: Apr. 30, 2026

(54) METHOD AND APPARATUS FOR IMPROVING ACCURACY OF NATURAL LANGUAGE TO SQL TRANSLATION

(71) Applicant: Informatica LLC, Redwood City, CA (US)

(72) Inventor: Igor BALABINE, Menlo Park, CA (US)

(21) Appl. No.: 18/928,671

(22) Filed: Oct. 28, 2024

(51) Int. Cl. G06F 16/2452; G06F 16/242; G06F 40/30

(52) U.S. Cl. CPC G06F 16/24522; G06F 16/243; G06F 40/30

(57) ABSTRACT

A method and apparatus for evaluating accuracy of artificial intelligence (AI) responses to queries involving translating natural language (NL) queries into structured query language (SQL) statements includes receiving an original NL query from a user, generating a plurality of semantically equivalent NL queries based on the original NL query, translating the original NL query and each of the plurality of semantically equivalent NL queries into corresponding NL2SQL translations using an AI-based natural language to structured query language (NL2SQL) translation model, executing each of the NL2SQL translations to determine corresponding execution results, extracting hyperparameters from the original NL query, evaluating the execution results based on the extracted hyperparameters, and producing a description of findings based on the result of the assessment.

### TECHNICAL FIELD

Example embodiments generally relate to Natural Language to SQL (NL2SQL) systems, and more particularly, to apparatuses and methods for improving accuracy of AI-based NL2SQL systems based on semantic analysis, and computational intent determination.

### BACKGROUND

Natural language to structured query language (NL2SQL) systems are increasingly being used in various fields to allow users to interact with databases using natural language queries. Such systems enable users to obtain specific data without need to write complex SQL code. NL2SQL systems are especially beneficial for non-technical users, as they simplify data access and querying.

Despite the advancements in NL2SQL systems, validating the accuracy of the SQL statements generated by artificial models from natural language inputs remains challenging. The accuracy of these AI-generated statements is particularly important in business environments where erroneous SQL statements may lead to incorrect data retrieval and potential decision-making risks. In certain benchmark tests, such as those including the SPIDER dataset, execution accuracy of NL2SQL systems ranges from 12.2% to 65.7%, which is far from ideal for practical business use.

One of existing approaches to improve NL2SQL accuracy is debug it yourself (DIY) method, where the user interacts with the system, manually assessing the correctness of SQL statements and adjusting them if necessary. While the DIY method improves user experience, it introduces limitations, such as requiring high technical skills and increased data security concerns due to human intervention. Another approach includes mapping natural language queries to a pre-set collection of SQL statements, but this often fails to maintain the intent of the original query, leading to inaccuracies.

With these challenges, there is a clear need for methods that improve the accuracy and validation of AI-generated SQL queries while maintaining the natural language interaction that users expect. Current systems also fail to handle updates in underlying datasets and protect the semantic integrity of the user's original query.

To address these limitations, the present invention provides a novel approach that combines artificial intelligence with semantic analysis. The method generates multiple semantically equivalent queries from the user's original query, translates each into SQL query, and validates the execution results against the original query parameters. Within this context, an equivalent phrase (utterance) is defined as a correct and usable phrase in written English. By analyzing the execution results based on semantic equivalence and computational intent, the system evaluates stability and correctness of the underlying NL2SQL implementation offering improved robustness and precision in practical applications.

### BRIEF SUMMARY OF SOME EXAMPLES

Some example embodiments of the present invention provide a method and apparatus for improving accuracy of artificial intelligence (AI) responses to queries that involve translating natural language (NL) queries into structured query language (SQL) statements.

In one example embodiment, a method for improving accuracy of artificial intelligence (AI) responses to queries that involve translating natural language (NL) queries into structured query language (SQL) statements may be provided. The method may include receiving an original NL query from a user, generating a plurality of semantically equivalent NL queries based on the original NL query, and translating, by an AI-based natural language to structured query language (NL2SQL) translation model, the original NL query and each of the plurality of semantically equivalent NL queries into corresponding NL2SQL translations. The method may include executing each of the NL2SQL translations to determine corresponding execution results. The execution results may be compared and evaluated using the parameters extracted from the original query.

In another example embodiment, an apparatus for improving accuracy of artificial intelligence (AI) responses to queries that involve translating natural language (NL) queries into structured query language (SQL) statements may be provided. The apparatus may include one or more processors and one or more memories operatively coupled to at least one of the one or more processors and having instructions stored thereon that, when executed by at least one of the one or more processors, cause at least one of the one or more processors to receive an original NL query from a user, generate a plurality of semantically equivalent NL queries based on the original NL query, translate the original NL query and each of the plurality of semantically equivalent NL queries into corresponding NL2SQL translations using an AI-based natural language to structured query language (NL2SQL) translation model, execute each of the NL2SQL translations to determine corresponding execution results, compare the execution results, and evaluate the results using the parameters extracted from the original query.

### BRIEF DESCRIPTION OF THE SEVERAL VIEWS OF THE DRAWING(S)

Having thus described some embodiments of the present invention in general terms, reference will now be made to the accompanying drawings, which are not necessarily drawn to scale, and wherein:

FIG. 1 illustrates a functional block diagram of a system for generating an answer based on an original natural language (NL) query from an end user device interacting with a computing device according to an example embodiment;

FIG. 2 illustrates a functional block diagram for generating an answer based on an original NL query from a quality assurance (QA) user interacting with the computing device according to an example embodiment;

FIG. 3 illustrates a distance matrix with a Damerau-Levenshtein distance between an execution result of an example original NL query and execution results of a plurality of semantically equivalent NL queries according to an example embodiment;

FIG. 4 illustrates the example original NL query with identified named entities according to an example embodiment;

FIG. 5 illustrates a dependency graph of the example original NL query according to an example embodiment;

FIG. 6A illustrates a database schema in accordance with an example embodiment;

FIG. 6B illustrates a knowledge graph in accordance with an example embodiment;

FIG. 6C illustrates a process for parsing a query in accordance with an example embodiment;

FIG. 7 illustrates a process for parsing a different query in accordance with an example embodiment;

FIG. 8 illustrates a flowchart of a method for improving accuracy of artificial intelligence (AI) responses to queries involving translating NL queries intro structured query language (SQL) statements according to an example embodiment;

FIG. 9 illustrates a flowchart of a second method for comparing execution results based on the evaluation algorithm according to an example embodiment; and

FIG. 10 illustrates an exemplary computing environment that can be used to carry out the method for improving accuracy of artificial intelligence (AI) responses to queries involving translating NL queries intro structured query language (SQL) statements according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability, or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, the phrase “operable coupling” and variants thereof should be understood to relate to direct or indirect connection that, in either case, enables functional interconnection of components that are operably coupled to each other.

As used in herein, the term “tool” is intended to include a computer-related entity, such as but not limited to hardware, firmware, or a combination of hardware and software (i.e., hardware being configured in a particular way by software being executed thereon). For example, a tool may be, but is not limited to being, a process running on a processor, a processor (or processors), an object, an executable, a thread of execution, and/or a computer. By way of example, both an application running on a computing device and/or the computing device can be a tool. One or more tools can reside within a process and/or thread of execution and a tool may be localized on one computer and/or distributed between two or more computers. In addition, these components can execute from various computer readable media having various data structures stored thereon. The tools may communicate by way of local and/or remote processes such as in accordance with a signal having one or more data packets, such as data from one tool interacting with another tool in a local system, distributed system, and/or across a network such as the Internet with other systems by way of the signal. Each respective tool may perform one or more functions that will be described in greater detail herein. However, it should be appreciated that although this example is described in terms of separate tools corresponding to various functions performed, some examples may not necessarily utilize modular architectures for employment of the respective different functions. Thus, for example, code may be shared between different tools, or the processing circuitry itself may be configured to perform all of the functions described as being associated with the tools described herein. Furthermore, in the context of this disclosure, the term “tool” should not be understood as a nonce word to identify any generic means for performing functionalities of the respective tools. Instead, the term “tool” should be understood to be a component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments described herein provide for a natural language to structured query language (NL2SQL) translation model that can be instantiated at an apparatus comprising configurable processing circuitry. The processing circuitry may be configured to execute various processing functions on natural language queries using the techniques described herein. Unlike conventional systems, the NL2SQL translation model may be configured to not only translate the original natural language query but also generate semantically equivalent natural language queries. Each of these equivalent queries, along with the original query, can be translated into corresponding SQL statements. These SQL statements are then executed on one or more databases, optimizing query results based on user intent. This process provides users with enhanced flexibility in managing and interacting with their data, allowing them to query multiple databases or other data sources efficiently through natural language inputs. By analyzing user intent at multiple levels, such as semantic, syntactic, and computational intent, the system evaluates the accuracy and relevance of the query results.

The NL2SQL translation model described herein further streamlines the user interaction with the system by offering tools that allow users to evaluate the query translation process interactively.

This model continuously evaluates query results and execution by using a set of semantically equivalent queries in addition to the original query. The system facilitates interactions for various types of users, including developers, quality assurance personnel, and end-users, allowing for a flexible and unified query execution validation experience. It maximizes access to structured data by minimizing the complexity associated with interacting with different databases while ensuring that the results reflect the user's true intent.

Within this general context, it should be noted that when evaluating query translation accuracy specifically, there are multiple factors that must be considered, one of the most important being user intent. This intent can be evaluated into different levels, including semantic intent (the meaning conveyed by the query), syntactic intent (the structural form of the query), and computational intent (the specific outcome or action the user expects to achieve through the query). In this invention, the system first determines the computational intent of the original natural language (NL) query. Following this, both the original NL query and a set of semantically equivalent NL queries are translated into SQL statements. The execution results of both the original query and the semantically equivalent queries are compared against the computational intent to ensure alignment with the desired outcome. This comparison evaluates the translation process, ensuring that the SQL execution results accurately reflect the user's expectations, even when multiple variations of the input query are considered. The complexity arises from the unstructured nature of NL inputs, where users may express the same query in diverse and ambiguous ways. Thus, the system validates that the underlying NL2SQL model may parse and interpret these various intents to generate SQL translations that meet the user's computational needs accurately.

Traditional methods of query translation validation often rely on basic syntactic analysis, which can only provide surface-level approximations of user intent. While these techniques may yield acceptable results in straightforward cases, they struggle with more complex or ambiguous natural language inputs. The NL2SQL translation validation model described herein overcomes these limitations by dynamically interpreting user intent through both the original natural language (NL) query and multiple semantically equivalent NL queries. The system translates these queries into SQL statements and then compares the execution results of each query, including the semantically equivalent queries, against the computational intent determined from the original NL query. By comparing execution results across these multiple queries, the model ensures that the SQL outputs align with the user's desired outcomes, even when the input is complex. This approach evaluates both accuracy and relevance of the generated SQL queries.

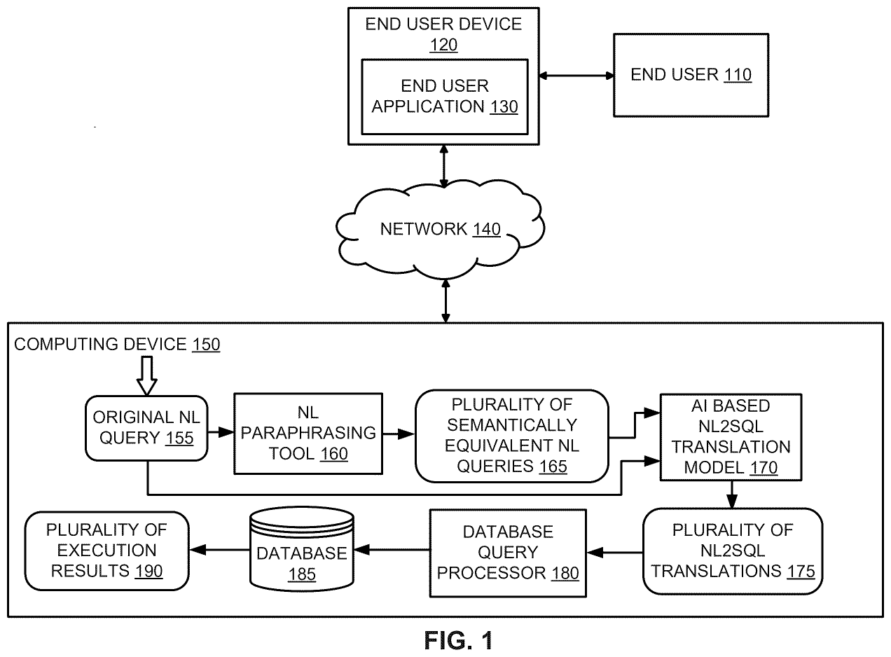

An example embodiment will now be described in reference to FIG. 1, which illustrates an example system in which an embodiment of the present invention may be employed. As shown in FIG. 1, a system according to an example embodiment may include an end user 110. Notably, although FIG. 1 illustrates a single end user 110, it should be appreciated that many more end users 110 may be included in some embodiments and thus, the single end user 110 of FIG. 1 is simply used to illustrate a potential of the end user 110, and the number of end user 110 is in no way limiting to other example embodiments. In this regard, example embodiments are scalable to include any number of end user 110.

In an example embodiment, the end user 110 may interact with the system by using an end user device 120. The end user device 120 may be a variety of computing devices such as a smartphone, tablet, laptop, desktop computer, or other network-connected devices capable of running required end user application 130. The end user 110 may employ these devices to access the functionalities offered by the system, particularly to submit an original natural language query (original NL query 155) and receive corresponding answer. The end user 110 may represent individuals, such as data analysts, decision-makers, or any users who lack technical SQL expertise but needs to query datasets.

The end user device 120 may execute the end user application 130 (e.g., CLAIRE GPT), a natural language interface that allows the end user 110 to input original NL queries. The end user application 130 may provide an interface where the end user 110 can input questions or data queries in a natural language format. For example, the end user 110 may input the original NL query 155 like “Show three customers who made the largest purchases in February 2022, date of purchase and the amount.” The end user application 130 may act as a communication layer between the end user 110 and the underlying system, transmitting the original NL query 155 over a network 140 to a computing device 150 for processing.

The end user application 130 may display the answer or execution results generated by the computing device 150, allowing the end user 110 to review the answer or the execution results. In some embodiments, the end user application 130 may enable interactive refinements based on these execution results, allowing the end user 110 to modify the original NL query 155 or provide additional instructions to further refine the original NL query 155.

In an example embodiment, the communication between the end user device 120 and the computing device 150 is facilitated by the Network 140. The network 140 may be a data network, such as one or more instances of a local area network (LAN), a wide area network (WAN), or the Internet, which enables the end user 110 to communicate with the underlying system remotely. The network 140 may support wireline or wireless communication protocols, allowing data to be exchanged between the end user device 120 and various components of the system.

The computing device 150, located within the system, is responsible for processing the original NL query 155 and generating corresponding NL2SQL translations through an AI-based NL2SQL translation model 170. As illustrated in FIG. 1, once the original NL Query 155 is transmitted from the end user device 120 via the network 140, the computing device 150 receives the original NL query 155 for further processing.

The computing device 150 may include various sub-components such as an NL paraphrasing tool 160 (which, in some embodiments, may be powered by linguistic platforms such as Ludwig and the like). The NL paraphrasing tool 160 may generate a plurality of semantically equivalent NL queries 165 from the original NL query 155. For example, if the original NL query 155 (ground truth query) is “Show three customers who made the largest purchases in February 2022, date of purchase and the amount,” semantically equivalent NL queries 165 generated by the NL paraphrasing tool 160 may include, “Display the top three customers with the highest purchase amounts in February 2022, including the date and total amount of their purchases,” “Present the three customers who spent the most in February 2022, along with the data and value of their purchases,” “Highlight the top three customers who made the biggest purchases in February 2022, specifying the date and amount of each purchase,” “Exhibit the three customers with the largest transactions in February 2022, showing the date and total amount spent,” and “Feature three customers who had the highest purchase totals in February 2022, including the purchase date and amount.”

It should be appreciated that the number of semantically equivalent NL queries 165 generated by the NL paraphrasing tool 160 is predefined by an administrator of the system. In some embodiments, the administrator may configure the system to generate a desired quantity of semantically equivalent queries, depending on complexity of the original NL query 155. Although the example provided illustrates five semantically equivalent queries, this number is in no way limiting to the invention. The system is scalable and can be configured to produce any suitable number of semantically equivalent queries, whether more or fewer than five but not less than one, based on administrator preferences or the requirements of the task at hand.

These semantically equivalent NL queries 165 may be processed by the AI-Based NL2SQL translation model 170, which converts both the original NL query 155 and the semantically equivalent NL queries 165 into a plurality of NL2SQL translations 175. The AI-Based NL2SQL translation model 170 may employ advanced natural language processing (NLP) and machine learning techniques to ensure that the plurality of NL2SQL translations 175 accurately reflect intent of the original NL query 155.

Once generated, the plurality of NL2SQL translations 175 may be executed by a database query processor 180 on a database 185, which stores data. The database 185 may represent a relational database or any suitable data repository that is capable of handling the plurality of NL2SQL translations 175. The database query processor 180 may process each of the plurality of NL2SQL translations 175 and returns a plurality of execution results 190.

In some embodiments, using a greater number of semantically equivalent NL queries 165, which are to be fed into the AI-Based NL2SQL translation model 170, allows for a better evaluation of the robustness of underlying AI model, enabling a more comprehensive investigation of its capabilities. In this regard, increasing the number of semantically equivalent NL queries 165 facilitates maintaining consistency and accuracy across different linguistic expressions of the same intent. This, in turn, ensures that the system can accommodate the diverse ways the end user 110 may phrase similar queries in natural language.

It is also appreciated that one or more named entities such as personally identifiable information (PII) and other sensitive data within the original NL query 155 or semantically equivalent NL queries 165 may be encrypted or obfuscated before being processed by the NL paraphrasing tool 160. This encryption ensures that sensitive information is protected throughout process without affecting the semantic or grammatical variations performed by the NL paraphrasing tool 160 because the one or more named entities are not part of linguistic variation, allowing them to be handled securely, without compromising integrity of paraphrasing process.

After generating the semantically equivalent NL queries 165, the computing device 150 prompts the AI-Based NL2SQL translation model 170 to generate the plurality of NL2SQL translations 175. The AI-Based NL2SQL translation model 170 may process both the original NL query 155 and each of the semantically equivalent NL queries 165, generating the plurality of NL2SQL translations 175 that attempt to preserve intent of the original NL query 155. In some embodiments, the computing device 150 may utilize generative pre-training transformer (GPT) service (e.g., CLAIRE GPT) to process the original NL query 155 (ground truth query) and the semantically equivalent queries 165. The computing device 150 may evaluate the plurality of NL2SQL translations 175 using a test dataset (e.g., CONTOSO dataset).

In some embodiments, the AI-Based NL2SQL translation model 170 may produce distinct NL2SQL translations 175 for different queries. For example, NL2SQL translation A may be produced for the original NL query 155 and one of the semantically equivalent NL queries 165, while NL2SQL translation B may be produced for other semantically equivalent queries of the semantically equivalent NL queries 165. For example, the NL2SQL translation A may be as follows:

```
SELECT
  CUSTOMERS.FIRST_NAME,
  CUSTOMERS.LAST_NAME,
  ORDERS.ORDERDATE,
  ORDERS.TOTAL_AMOUNT
FROM
  PLATFORMQA.RETAIL_NEW.CUSTOMERS AS CUSTOMERS
  JOIN PLATFORMQA.RETAIL_NEW.ORDERS AS ORDERS ON
CUSTOMERS.CUSTOMERID = ORDERS.CUSTOMERID
WHERE
  EXTRACT(MONTH FROM ORDERS.ORDERDATE) = 2
  AND EXTRACT(YEAR FROM ORDERS.ORDERDATE) = 2022
ORDER BY
  ORDERS.TOTAL_AMOUNT DESC
LIMIT 3;
```

Similarly, the NL2SQL translation B may differ slightly in handling date ranges, as seen in the following example:

```
SELECT
  CUSTOMERS.FIRST_NAME,
  CUSTOMERS.LAST_NAME,
  ORDERS.ORDERDATE,
  ORDERS.TOTAL_AMOUNT
FROM
  PLATFORMQA.RETAIL_NEW.CUSTOMERS AS CUSTOMERS
JOIN
  PLATFORMQA.RETAIL_NEW.ORDERS AS ORDERS
ON
  CUSTOMERS.CUSTOMERID = ORDERS.CUSTOMERID
WHERE
  ORDERS.ORDERDATE BETWEEN ‘2022-02-01’ AND ‘2022-02-28’
ORDER BY
  ORDERS.TOTAL_AMOUNT DESC NULLS LAST
LIMIT 3;
```

Once the AI-Based NL2SQL translation model 170 has generated the NL2SQL translations 175, the database query processor 180 may execute these NL2SQL translations on the database 185. Each NL2SQL translation may return execution results, with the execution result of the original NL query 155 being denoted as R and the execution results for each of the semantically equivalent NL queries 165 denoted as Ri. These execution results are collected for further comparison and evaluation.

During execution result comparison phase, the computing device 150 analyzes how closely the execution results Ri of the semantically equivalent NL queries match the ground truth execution result R. To evaluate diversity of the execution results, the computing device 150 may determine a distance between the execution result R and each of the execution results Ri, using a distance measure. The determination of the distance may include generating a distance matrix containing a Damerau-Levenshtein distance between the execution result R of the original NL query and the execution results Ri of the semantically equivalent NL queries 165.

The execution results may be tables containing various elements such as strings or numeric values. When comparing two execution results, the computing device 150 may traverse rows of each table, associating each element in a respective row with a character from an alphabet A (e.g., {a1, a2, . . . }). In an example embodiment, the computing device 150 may assign same character to both elements if values of the respective elements are equal. Alternatively, different characters are assigned to the elements if the values differ. For example, consider two execution results tables

$$T 1 = \begin{matrix}\begin{matrix}v 1 \\ …\end{matrix} \\ vn\end{matrix} \begin{matrix}\begin{matrix}b 1 \\ …\end{matrix} \\ bn\end{matrix} and T 2 = \begin{matrix}\begin{matrix}v 1 \\ …\end{matrix} \\ vn\end{matrix} \begin{matrix}\begin{matrix}c 1 \\ …\end{matrix} \\ cn\end{matrix} ,$$

respectively, the computing device 150 then maps a first row of the execution result table T1 to the alphabet A, obtaining a character representation a1a2. In this regard, character a1 may be used to represent a string value v1, while a2 represents a string value b1. Repeating this mapping process for a first row of the execution result table T2 in a character sequence a1a3 because a string value c1, in T2, has not been mapped to any character in the alphabet A.

As the computing device 150 compares the execution result tables T1 and T2, it accounts for isomorphic transpositions of rows and columns. For example, if columns A and B in the result tables are swapped, matrix R1={A, B} is considered isomorphic to matrix R2={B, A}. In this regard, the computing device 150 may treat the two matrices as identical for comparison.

Mapping the values from the execution result tables to character strings while accounting for isomorphic transpositions provides the computing device 150 with the distance matrix, referred to as the Damerau-Levenshtein distance. The distance matrix may be used to evaluate the similarity between the execution results of the original NL query 155 and the execution results of the semantically equivalent NL queries 165.

In an exemplary embodiment, since the semantically equivalent NL queries 165 are generated from the original NL query 155, all corresponding execution results (i.e., R and Ri) should match exactly. However, as seen in the example use case, different queries can sometimes produce identical execution results. For example, the computing device 150 generated identical results for the ground truth query (i.e., “Show three customers who made the largest purchases in February 2022, date of purchase and the amount,”) and the semantically equivalent NL queries 165 noted above, Table 1 below may be provided as the output of the model:

TABLE 1

| FIRST_NAME | LAST_NAME | ORDERDATE | TOTAL_AMOUNT |
|---|---|---|---|
| Charles | Simmons | Feb. 25, 2022 | 3199.96 |
| Matthew | Barnes | Feb. 21, 2022 | 1599.96 |
| Lisa | Ross | Feb. 25, 2022 | 999.98 |

Based on the similarity between the execution results 190 for the original NL query 155 and the semantically equivalent NL queries 165, the computing device 150 may conclude that the NL2SQL translation model 170 is stable. In some embodiments, the computing device 150, after executing the NL2SQL translations 175 for both the original NL query 155 and the semantically equivalent NL queries 165, may encounter different execution results. When discrepancies are identified between the execution results 190, the computing device 150 compares the results based on a distance metric.

In some embodiments, the computing device 150 comparing the execution results 190 may extract semantic binary relations from the original NL query 155 and determine the one or more named entities in the original NL query 155. The comparison of the execution results 190 may further include mapping natural language utterances in the original NL query 155 to computable logical forms. The computing device 150 may generate parameterized logical forms by combining the computable logical forms with the extracted semantic binary relations and the one or more named entities. The computing device 150 may compute the parameterized logical forms to determine a computational intent of the original NL query 155.

The method disclosed herein is useful for quality assessment of the AI-based NL2SQL translation model 170. By generating a semantical variety of natural language queries, the system may thoroughly examine robustness of the NL paraphrasing tool, its stability, and the adaptivity of the AI-based NL2SQL translation model 170 to diverse natural language queries.

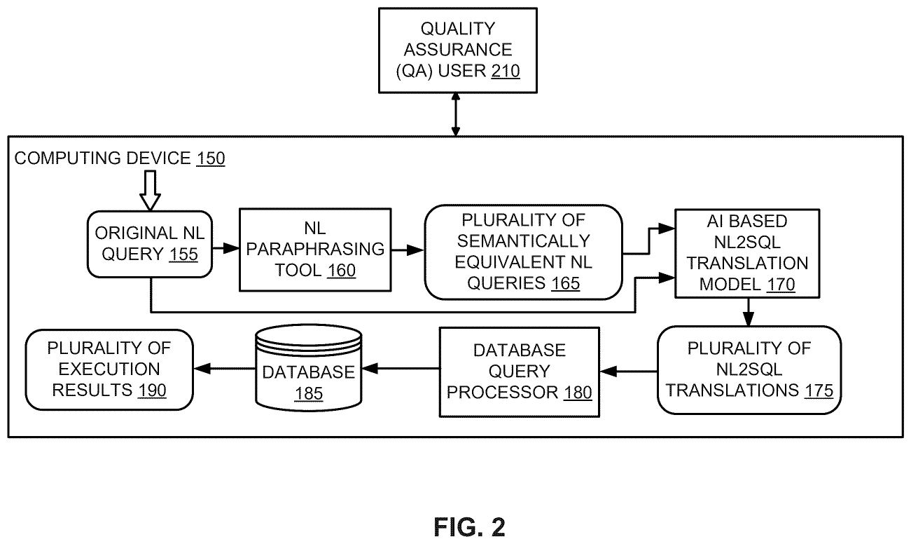

An example embodiment of the invention is further illustrated in FIG. 2, which represents a system architecture for improving execution results in an NL2SQL environment. As depicted in FIG. 2, the system includes quality assurance (QA) user 210, who actively participates in configuring the system and improving its execution results, rather than serving as a consumer such as the end user 110 of the execution results.

The computing device 150 receives an original NL query 155 from the QA user 210, and the original NL query 155 is processed by the NL paraphrasing tool 160 within the computing device 150. The NL paraphrasing tool 160 may generate a plurality of semantically equivalent NL queries 165 from the original NL query 155. The semantically equivalent NL queries 165 are then transmitted to the AI-based NL2SQL translation model 170, which converts the original NL query 155 and the semantically equivalent NL queries 165 into a plurality of NL2SQL translations 175.

These NL2SQL translations 175 may be executed by the database query processor 180 on the database 185, producing a plurality of execution results 190. The QA user 210 may interact with the computing device 150 by providing specific configuration inputs, such as entering a desired quantity of the semantically equivalent NL queries 165 to be considered. The desired quantity may allow the computing device 150 to adjust generation of semantically equivalent queries based on predefined parameters.

The QA user 210 may interact with the computing device 150 to select one or more of the generated semantically equivalent NL queries 165. Moreover, the computing device 150 may allow the QA user 210 to input additional semantically equivalent NL queries 165 beyond automatically generated by the NL paraphrasing tool 160. In an example embodiment, the QA user 210 has control to either accept, reject, or modify the semantically equivalent NL queries being processed. Once the execution results 190 are generated, the computing device 150 may compare the execution results 190 using a distance metric.

The computing device 150 comparing the execution results 190 may extract semantic binary relations from the original NL query 155 and determine one or more named entities in the original NL query 155. The QA user 210 may interact with the computing device 150 to confirm the one or more named entities and the extracted binary relations, ensuring that they align with intent of the original NL query 155, thereby validating the accuracy and reliability of the generated NL2SQL translations 175.

The comparison of execution results 190 may further include mapping natural language utterances in the original NL query 155 to computable logical forms. The computing device 150 may generate parameterized logical forms by combining the computable logical forms with the extracted semantic binary relations and the one or more named entities. The QA user 210 may review and confirm the parameterized logical forms, ensuring that they properly represent the computational structure of the original NL query 155. The computing device 150 may compute the parameterized logical forms to determine a computational intent of the original NL query 155.

In some embodiments, the evaluation algorithm executed by the computing device 150 may perform shallow semantic parsing on the original NL query 155 to determine the computational intent of the query. The QA user 210 may review and confirm the computational intent determined by the shallow semantic parsing of the original NL query 155 to ensure that meaning of the original NL query 155 is properly interpreted by the computing device 150. The computing device 150 may present the execution results 190 to the QA user 210 for analysis. This includes both the execution result of the original NL query 155 and the execution results of the semantically equivalent NL queries 165.

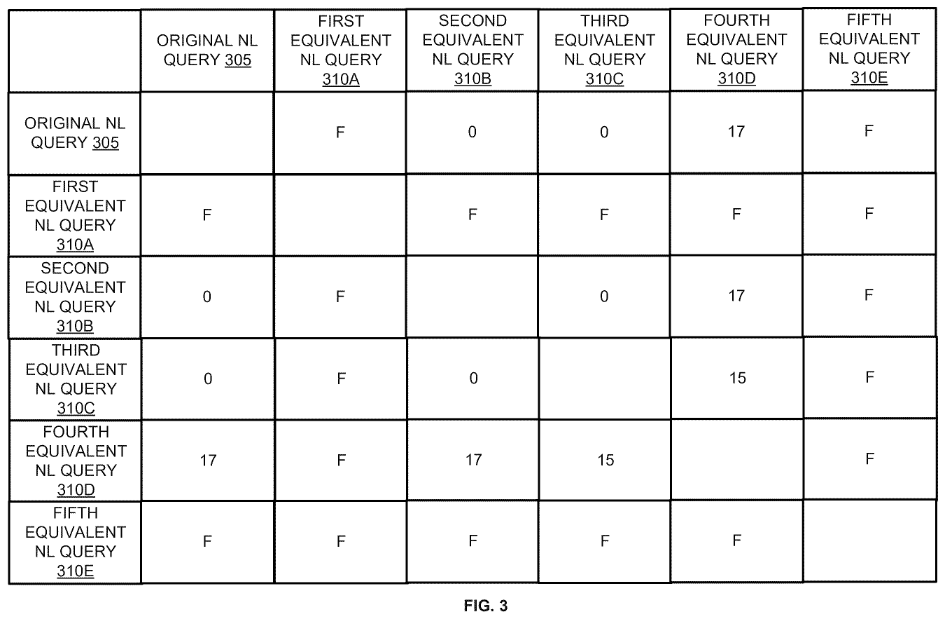

FIG. 3 illustrates a distance matrix with a Damerau-Levenshtein distance between an execution result of an example original NL query 305 and execution results of a plurality of semantically equivalent NL queries 310A-310E according to an example embodiment. The distance matrix may quantify differences between the execution results based on how closely the semantically equivalent NL queries align with the execution result of other NL queries.

In an example embodiment, the original NL query 305 is “Show five customers older than 30 years who placed largest orders in February 2022 and their date of birth,” and the semantically equivalent NL queries 310A-310E include variations of this original NL query 305, such as “Display the date of birth for five customers over the age of 30 who made largest purchases in February 2022,” “Provide the named and dates of birth for five customers over 30 who made largest orders in February 2022,” “Present the birthdates of five customers who are older than 30 and placed largest orders in February 2022,” “Show the birthdates of five customers who are above 30 years old and placed largest orders in the month of February 2022” and “List the dates of birth for five customers who are over the age of 30 and made largest purchases in February 2022.”

In response to the original NL query 305, along with the semantically equivalent NL queries 310A-310E, the AI-based NL2SQL translation model 170 may generate various execution results. For example, in response to the original NL query 305 and the semantically equivalent NL query 310B, the computing device 150 may produce identical execution results containing only one customer with the following details:
FIRST_NAME, LAST_NAME, DOB
“Laura,” “Young,” “Jul 03, 1972.”

Similarly, for semantically equivalent NL query 310C, the computing device 150 generated an execution result with the same customer information, but with the columns being transposed:
DOB, FIRST_NAME, LAST_NAME
“Jul 03, 1972,” “Laura,” “Young.”

The execution result for semantically equivalent NL query 310C is isomorphic to the execution results generated for the original NL query 305 and semantically equivalent NL query 310B. The computing device 150 may treat these execution results as equivalent since only difference lies in the arrangement of the columns, which does not affect content of the execution result.

The execution result for semantically equivalent NL query 310D provided a distinct set of customers with multiple entries, as shown below:
DOB, FIRST_NAME, LAST_NAME
Jul. 25, 1998, Lisa, Ross
Mar. 28, 1997, Stephanie, Phillips
May 9, 1999, Patricia, Evans
Sep. 19, 1995, James, Cook
Dec. 5, 1996, Martin, Watson.

Each cell in the distance matrix represents the Damerau-Levenshtein distance between the corresponding queries. In an example embodiment, a value of 0 signifies that the execution results for two queries are identical, while higher values represent larger discrepancies. Moreover, the symbol “F” denotes cases where the query failed to produce a result.

For example, the computing device 150 returned identical results (distance of 0) for the original NL query 305 and the semantically equivalent queries 310B (second equivalent NL query) and 310C (third equivalent NL query), but it produced distinct results for semantically equivalent query 310D (fourth equivalent NL query) with a Damerau-Levenshtein distance of 17. The difference indicates that the execution result of query 310D did not align closely with the original NL query 305 or other equivalent queries. Similarly, the semantically equivalent query 310A (first equivalent NL query) failed to produce a result (denoted as F), along with query 310E (fifth equivalent NL query), highlighting instances where the computing device 150 did not generate a response.

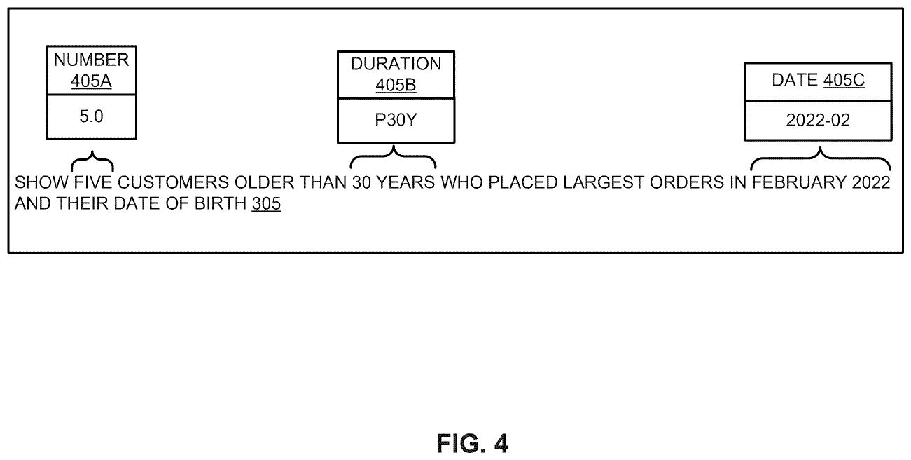

FIG. 4 illustrates the example original NL query 305 with identified named entities according to an example embodiment. The computing device 150 may process the original NL query 305 using natural language processing (NLP) techniques such as named entity recognition (NER) to extract key entities from the original NL query 305.

As depicted in FIG. 4, the named entities recognized by the NER parser include a NUMBER 405A, representing the value “5.0,” a DURATION 405B, representing the value “P30Y” (meaning a period of 30 years), and a DATE 405C, representing “February 2022.” These identified named entities may correspond to the key entities in the original NL query 305 that define specific constraints of user's request, such as the number of customers, the age restriction, and the date of the largest orders.

For example, the NUMBER 405A in the original NL query 305 refers to the request for “five” customers, while the DURATION 405B corresponds to the “older than 30 years” constraint, and the DATE 405C specifies “February 2022.” The computing device 150 uses these identified named entities to fragment the original NL query 305 and refine the NL2SQL translations 175 to ensure the generated execution results 190 accurately reflect the user's intent.

In an example embodiment, this extraction process is facilitated using a natural language processing library (e.g., Stanford CoreNLP library), which tokenizes the natural language query, identifies parts of speech, and recognizes named entities within the query. The resulting annotations, as illustrated in FIG. 4, provide a detailed mapping of the key elements in the original NL query 305, allowing the system to better understand and process the query for execution.

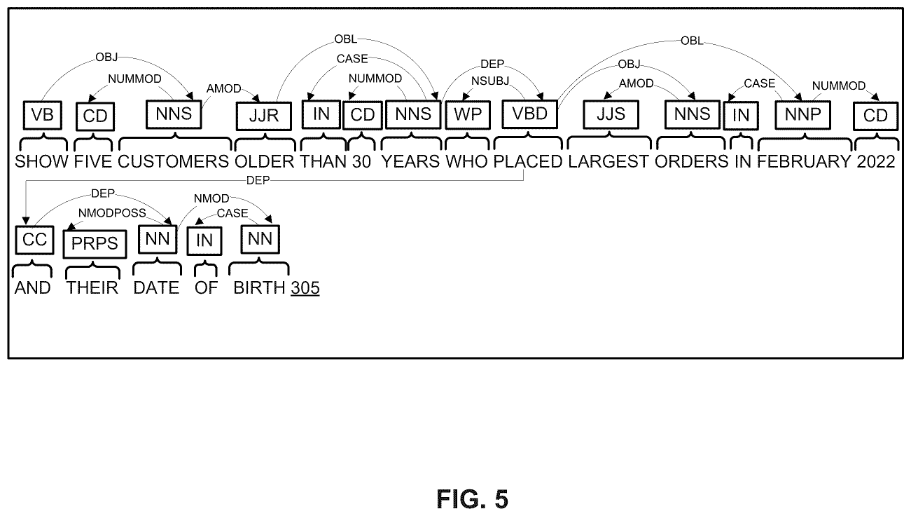

FIG. 5 illustrates a dependency graph of the example original NL query 305 according to an example embodiment. The dependency graph may highlight syntactic relationships between various terms in the original NL query 305. Each term in the example original NL query 305 “Show five customers older than 30 years who placed largest orders in February 2022 and their date of birth” is annotated with its corresponding Penn Treebank part of speech (PoS) tag.

The terms in the example original NL query 305 are annotated as follows: VB (Verb) for term “Show”, CD (Cardinal Number) for term “five”, NNS (Plural Noun) for term “customers”, JJR (Comparative Adjective) for term “older”, IN (Preposition) for term “than”, CD (Cardinal Number) for term “30”, NNS (Plural Noun) for term “years”, WP (Wh-pronoun) for term “who”, VBD (Verb, Past Tense) for term “placed”, JJS (Superlative Adjective) for term “largest”, NNS (Plural Noun) for term “orders”, IN (Preposition) for term “in”, NNP (Proper Noun) for term “February”, CD (Cardinal Number) for term “2022”, CC (Coordinating Conjunction) for term “and”, PRPS (Possessive Pronoun) for term “their”, and NN (Noun, Singular) for term “date and birth”.

In an example embodiment, dependency links between the terms define the sentence structure and guide the natural language understanding: obj (Object) links show (VB) to customers (NNS), nummod (Numeric Modifier) links five (CD) to customers (NNS), amod (Adjectival Modifier) connects older (JJR) to customers (NNS), obl (Oblique Nominal) links older (JJR) to years (NNS), case connects than (IN) to years (NNS), nummod (Numeric Modifier) links 30 (CD) to years (NNS), nsubj (Nominal Subject) links placed (VBD) to who (WP), dep (Dependent) links years (NNS) to placed (VBD), obj (Object) links placed (VBD) to orders (NNS), amod (Adjectival Modifier) connects largest (JJS) to orders (NNS), obl (Oblique Nominal) connects placed (VBD) to February (NNP), dep (Dependent) also links placed (VBD) to and (CC), nummod (Numeric Modifier) links 2022 (CD) to February (NNP), dep (Dependent) links and (CC) to date (NN), nmod (Possessive Nominal Modifier) links their (PRPS) to date (NN), nmod (Nominal Modifier) links date (NN) to birth (NN), and case links of (IN) to birth (NN).

The PoS tags, along with the identified named entities and dependencies between the terms, enable an ad hoc interpretation of parameters of the original NL query 305. For example, a cardinal number (CD) term followed by a plural noun (NNS) is a strong indicator of a selected quantity. Similarly, the combination of five (CD) followed by customers (NNS) may suggest the example original NL query 305 is seeking five specific customers. Correspondingly, a comparative adjective (JJR) associated with a plural noun (NNS), such as older (JJR) followed by years (NNS), and linked to a number (CD) like 30, indicates a comparative clause that refines the condition of age for the customers.

To further enhance the natural language understanding, the computing device 150 may employ a process known as semantic parsing, which maps natural language utterances to machine-interpretable meaning representations. The computing device 150 may engage in shallow semantic parsing (semantic role labeling). The process may assign semantic roles to words and phrases in a sentence, helping define their function within the context of the example original NL query 305. For example, the computing device 150 may identify the subject, object, and action (e.g., customers placed orders), and label these elements with roles such as Agent (the doer), Action (the task), and Object (the item acted upon). Importantly, the shallow semantic parsing is an unsupervised learning technique, meaning it can learn from the data without explicit labeling, making it adaptable and scalable for various natural language queries.

It is appreciated that techniques, such as large language models (LLMs), may also be used for the semantic parsing of the original NL query. However, to avoid potential misinterpretation by the original parsing mechanism, the computing device 150 may employ a natural language processing tool (e.g., CoreNLP) to extract meaning of the original NL query accurately to ensure robustness and reduce reliance on a single method of semantic parsing.

In some example embodiments, the computing device 150 may construct a semantic parser according to a specific domain, leveraging tools (e.g., SEMPRE toolkit), which maps the natural language utterances to denotations (answers) through the intermediate logical forms. The semantic parser may be powered by a large database of mappings between the natural language utterances and logical forms, which can be extended with additional mappings as needed. The logical forms may then be executed to generate denotations, which provide final answers to the original NL query. Since objective of the system is to validate the execution results provided by the NL2SQL model, the system relies on both the annotated dependency graph and the identified named entities to ensure accuracy of the answer. To simplify the validation process, the system may fragment the original NL query into its constituent parts, including named entities, and the subject, verb, and object of the sentence, using the natural language processing tool. As such, there is an effective decomposition of the “ground truth” question into parts which contain either named entities or the subject, verb and object of the sentence using CoreNLP OpenIE annotator, which may construct OpenIE triplets (subject;verb;object) such as (customers; placed; orders). As such, the semantic parser may be understood to perform the general function of asking questions about the question (i.e., the original NL query 305).

For example, the example original NL query 305 includes a triplet (customers; placed; orders) which is identified using the natural language processing tool. By combining the triplet with the leveraging tools and the identified named entity “NUMBER” (in this case, 5), the computing device 150 may conclude that the user is requesting five samples. In examples where the number of samples deviates from expected quantity, the computing device 150 may raise a warning. Since the computing device 150 does not have access to the whole corpus the count deviations cannot be considered undisputable errors. For example, the query asks for 5 samples, but the corpus contains only 3 samples which match the query criteria.

In an exemplary embodiment, to simplify semantic processing the “ground truth” question Q may be split into a collection of “noun phrases”, words or groups of words that function in a sentence as subject, object, or prepositional object. In general, an adverbial noun phrases are a group of words of which the noun is the base word, that tells the time or place of an action, or how long, how far, or how much. It may be appreciated that use of noun phrases significantly streamlines semantic parsing of the prompts.

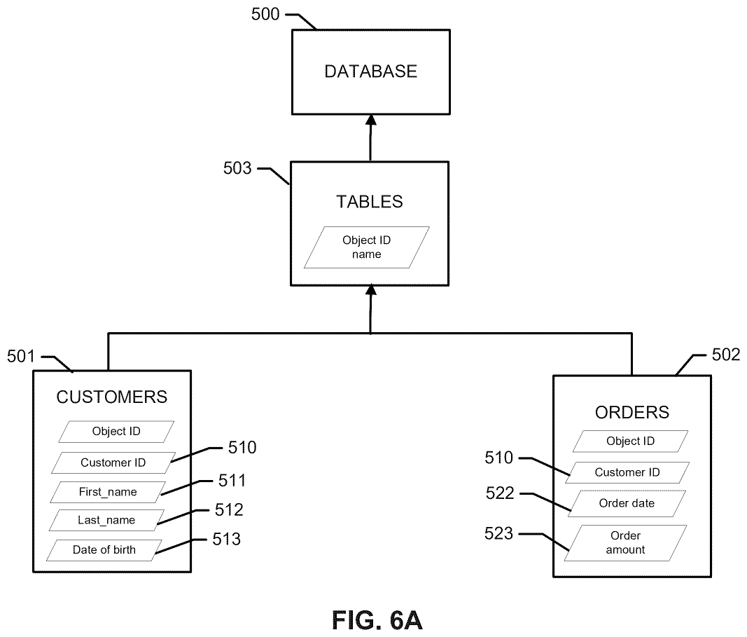

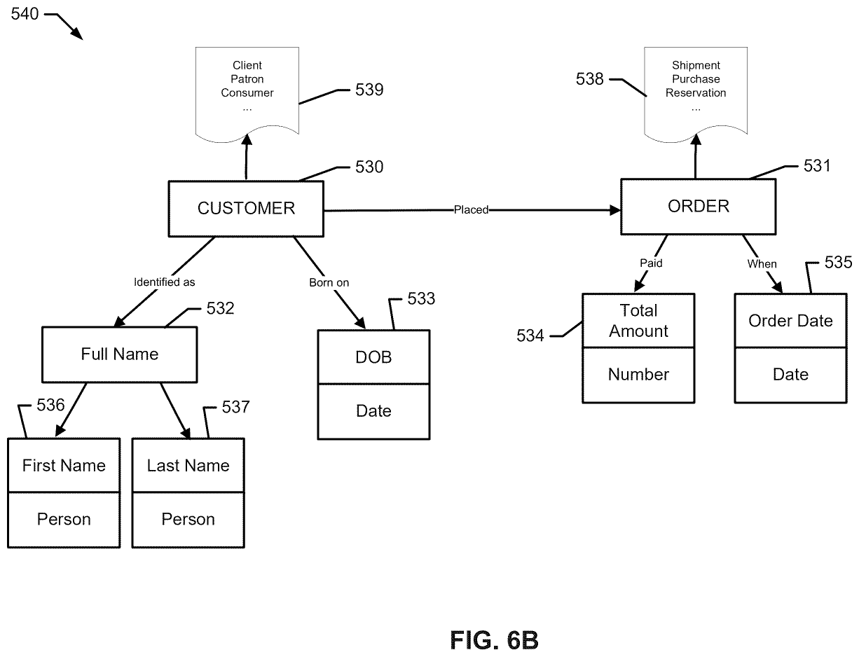

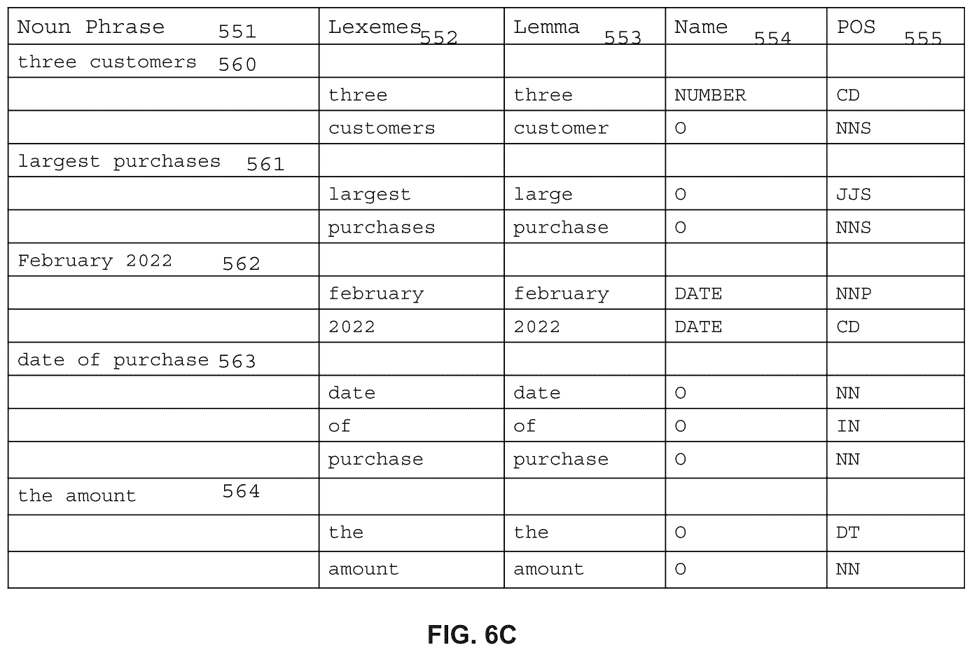

To illustrate one example mechanism for accomplishing this, FIG. 6A provides a snippet of a database schema. The database 500 contains a collection of tables including a list of tables 503, a list of customers 501, and a list of orders 502 placed by the customers. In FIG. 6, each customer in the list of customers 501 table is assigned a unique id (e.g., Object ID) and Customer ID 510. The list of customers 501 table also includes each customer's first name 511, last name 512, and date of birth 513. The orders placed by the customers are reflected in the list of orders 502 table. Each order is identified by the id of a customer who placed the order (i.e., Customer ID 510), order date 522, and the amount (i.e., Order amount 523).

In this illustration of the proposed mechanism, it may be desirable to extract certain information about purchases made by the customers. FIG. 6B depicts a Knowledge Graph 540 describing a fact that Customer 530 placed Order 531. The top-level objects, Customer 530 and Order 531, have a thesaurus 539 and 538, respectively, associated with each of them to define key words that may be associated with the respective topics. In this example model, Customer 530 is associated with his/her full name 532, which is further comprised of a first name 536 and last name 537, and date of birth, DoB 533. The Order 531 is characterized by an order date 535 when the order was fulfilled and the total amount 534 paid by Customer 530. The knowledge graph may be traversed to perform logical reasoning about the observed results of the prompts execution. Standard NER (Named Entity Recognition) designations (PERSON, NUMBER, DATE) may be used to identify the knowledge graph node data type.

Returning to the ground truth query mentioned above (i.e., “Show three customers who made the largest purchases in February 2022, date of purchase and the amount,”) for which Table 1 was the model output, FIG. 6C helps to illustrate the points outlined above even further. In this regard, processing of an exemplary “ground truth” prompt “Show three customers who made largest purchases in February 2022, date of purchase and the amount” yields at least five Noun Phrases 551 corresponding to the number of customers 560, comparative purchase amount qualifier 561, a period during which the orders 562 were placed, date of purchase 563 and the amount paid 564. Each Noun Phrase 551 is comprised of Lexemes 552 each of which is associated with that lexeme's Lemma 553 and a recognized object Name 554. When the “ground truth” prompt was parsed the corresponding Lexeme 552 part of speech POS 555 was determined.

Referring to FIG. 6C, in a next step the noun phrases 551 are parsed with the objective of determining correspondence between the query parameters and the output content. Using the lemmas 552 and the POS 555 of a first noun phrase 560 “three customers” it may be determined that the noun phrase 560 indicates the expected number of customers to be output. This derivation enables a verification to be made that that the output is expected to contain three entries.

Further referring to FIG. 6C, by examining the named entities type in the Name 554 column it can be determined that noun phrase 562 “February 2022” represents a date. Then the values in the ORDERDATE column may be extracted to verify that the dates in this column are indeed the dates in February of 2022. Further referring to 6C, the “amount” lexeme of noun phrase 564 may be examined and mapped to the TOTAL_AMOUNT column of the output. Then it may be possible to verify that the values in the TOTAL_AMOUNT column are numbers.

Further referring to 6C and 6B, the “largest purchases” 561 noun phrase is comprised of two lexemes, “largest” and “purchases”. The first lexeme is a superlative (POS tag JJS) which in combination with its lexeme “large” indicates that we are looking for a largest value. Using the thesaurus 538 for Order 531, the lemma “purchase” may be translated to correspond to the ORDER 531. This inference enables a validation that the values in the TOTAL_AMOUNT column of the response are reported in the descending order. It may be appreciated that since access may not be available to the whole data set, it cannot be verified that the values in the TOTAL_AMOUNT column are indeed largest for a given interval in the data set.

Based on similarity of the results of all queries and further validation of the query parameters with a high degree of confidence, it may be concluded that the output result is plausible and may be reported as such. A report may be produced describing the validation steps performed on the output of the query including the expected count of output records, the dates of purchase, and the assumption about the largest purchases made by the customers at that time. Notably, based on the structure of FIG. 6C, it should be appreciated that a similar graph can be constructed for the ground truth query “Show five customers older than 30 years who placed largest orders in February 2022 and their date of birth.”

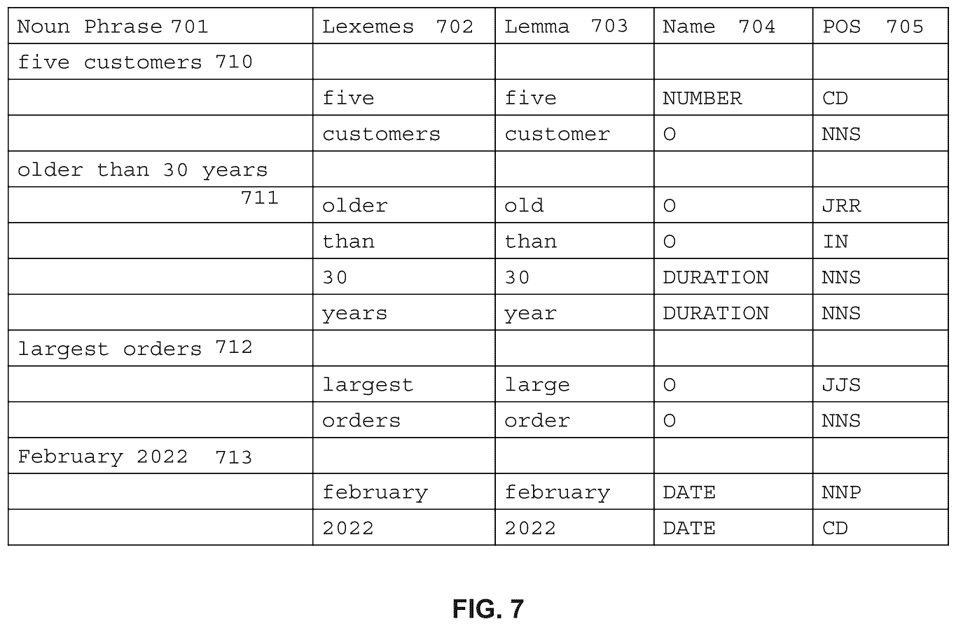

FIGS. 3 and 7 illustrate another example to demonstrate usefulness of example embodiments in identifying problems in the generated results by showing how hyperparameters other than counts may help with validation, and further describes a metric for evaluating the NL2SQL translation mechanism stability. In this regard, FIGS. 3 and 7 correspond to a method for quality assessment of the AI model robustness. Semantical variety of the natural language questions enable a thorough examination of the language model strength, stability, and the translation model adaptivity.

In relation to the example of FIGS. 3 and 7, the ground truth questions may be considered to be Prompt 1: “Show five customers older than 30 years who placed largest orders in February 2022 and their date of birth.” Following the process flow of FIG. 2, this original NL query may be paraphrased and then five semantically equivalent NL queries may be generated. The semantically equivalent NL queries may include:
Prompt 2: “Display the date of birth for five customers over the age of 30 who made largest purchases in February 2022.”
Prompt 3: “Provide the names and dates of birth for five customers over 30 who made largest orders in February 2022.”
Prompt 4: “Present the birthdates of five customers who are older than 30 and placed largest orders in February 2022.”
Prompt 5: “Show the birthdates of five customers who are above 30 years old and placed largest orders in the month of February 2022.”
Prompt 6: “List the dates of birth for five customers who are over the age of 30 and made largest purchases in February 2022.”

In response to Prompt 1 and Prompt 3 the AI model produced a response containing only one customer:
FIRST_NAME,LAST_NAME,DOB
“Laura”, “Young”, “Jul 03, 1972”

For Prompt 4 the AI model also produced a similar one entity response but with transposed columns:
DOB,FIRST_NAME,LAST_NAME
“Jul 03, 1972”, “Laura”, “Young”

As can be observed, the response to Prompt 4 is isomorphic to the responses for Prompt 1 and Prompt 3. The response to Prompt 4 can therefore be considered to be equivalent to the responses to Prompt 1 and Prompt 3.

At the same time, AI model response to Prompt 5 is distinct from other responses:

| DOB | FIRST_NAME | LAST_NAME |
|---|---|---|
| Jul. 25, 1998 | Lisa | Ross |
| Mar. 28, 1997 | Stephanie | Phillips |
| May 9, 1999 | Patricia | Evans |
| Sep. 19, 1995 | James | Cook |
| Dec. 5, 1996 | Martin | Watson |

Besides that, the AI model failed to provide responses to Prompt 2 and Prompt 6.

After calculating distance between the observed results, the distance matrix shown in FIG. 3 above may be generated. Referring to FIG. 7, in a next step we parse the noun phrases 701 with the objective of determining correspondence between the query parameters and the output content. Using the lemmas 703 and the POS 705 of a first noun phrase 710 “five customers” we determine that said noun phrase 710 indicates the expected number of customers to be output. This derivation allows a verification that the output is expected to contain five entries while only response to Prompt 5 provides five results. This may lead to a conclusion that the NL2SQL model in use is unstable.

Further referring to FIG. 7, neither the proposition about the “largest orders” 712 or the purchase date being in “February 2022” can be verified because the NL2SQL model failed to produce a relevant information.

Further referring to FIG. 7 and FIG. 3, the DOB column of the response can be mapped to the DOB 513 entry in the Knowledge Graph of FIG. 6A. The DOB column in the response enables validation of the “older than 30 years” noun phrase 711. An estimate on the “February 2022” date of the noun phrase 713 may provide basis for calculating age of the customers as of Feb. 28, 2022. This calculation identifies yet another deficiency of the AI model: all customers included in the response were younger than 30 years at the time of purchase.

Once the semantic parsing step is completed, the user may be presented with a list of findings that include:
Failed queries
Responses with a wrong number of entries
Missing information in the responses
Incorrect information in the responses

The user may also be provided with a metric of the NL2SQL translation stability, S, which is shown in Table 2 below. The metric of the NL2SQL translation stability, S, represents the number of diverse responses to the semantically equivalent queries. The metric may be derived from Shannon entropy

$$H = - {\sum }_{i = 1}^{R} {p}_{i} log {p}_{i} \text{?} ,$$

$$\text{?} \text{indicates text missing or illegible when filed}$$

where R is the number of diverse responses, pᵢ is a probability of observing the response i:

$$S = 1 - \overline{H}$$

where H̅ is a normalized value of Shannon entropy for a given collection of responses

$$\overline{H} = \frac{H}{{H}_{max}} \text{?} {H}_{{max}^{-}}$$

$$\text{?} \text{indicates text missing or illegible when filed}$$

Shannon entropy value for a case when all responses are different.

When all responses are the same or isomorphic the NL2SQL translation stability metric S=1. When the responses are diverse the NL2SQL translation stability metric decreases with the number of observed diverse responses and becomes 0 when all responses are different. If one or a plurality of queries fail to produce a result translation stability metric S=0. The following table provides an example of the translation stability metric values for different computation outcomes of 6 trials.

TABLE 2
Translation stability metric values for different
combinations of computation outcomes of 6 trials

| g1 | g2 | g3 | g4 | g5 | g6 | H | S |
|---|---|---|---|---|---|---|---|
| 6 | | | | | | 0 | 1.0 |
| 3 | 3 | | | | | 0.69 | 0.61 |
| 2 | 4 | | | | | 0.64 | 0.64 |
| 2 | 2 | 2 | | | | 1.10 | 0.39 |
| 1 | 5 | | | | | 0.45 | 0.75 |
| 1 | 2 | 3 | | | | 1.01 | 0.44 |
| 1 | 1 | 4 | | | | 0.87 | 0.52 |
| 1 | 1 | 2 | 2 | | | 1.33 | 0.26 |
| 1 | 1 | 1 | 3 | | | 1.24 | 0.31 |
| 1 | 1 | 1 | 1 | 2 | | 1.56 | 0.13 |
| 1 | 1 | 1 | 1 | 1 | 1 | 1.79 | 0 |

In Table 2, gi, i={1, 6} is a results group ordinal. For example, g1=3, g2=3 means that we observed two distinct results in 6 trials. The NL2SQL translation stability metric provides a succinct assessment of the NL2SQL translation mechanism robustness. It is appreciated that the result of the “ground truth” query along with the results of the semantically equivalent queries may be presented to the user for a further analysis. The semantic parsing step may also be bypassed, in some cases, and the results of the queries may be presented to the user for the analysis.

A tool may therefore be provided having a function for implementing the disclosed approach to be targeted towards the development and the QA audience. In this regard, for example, the disclosed technique may be used in a production environment to alert the user to the defects in the AI model response. In particular, upon completion of the semantic parsing step, the user may be presented with a set of responses accompanied by a brief explanation of the defects found in the produced results.

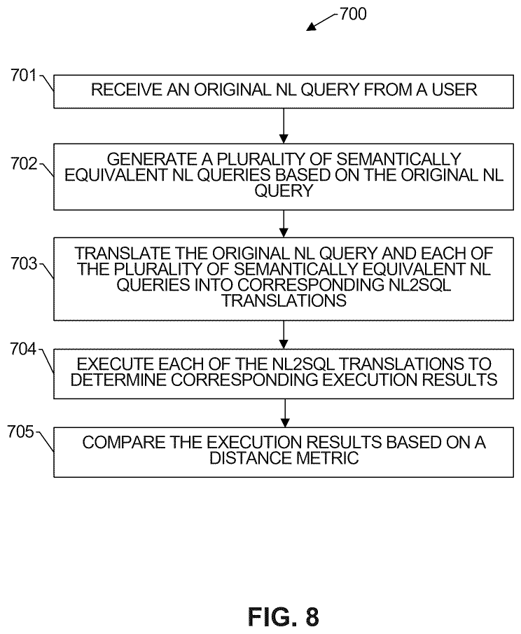

FIG. 8 illustrates a flowchart 700 of a method for validating the accuracy of artificial intelligence (AI) responses to queries involving translating natural language (NL) queries into structured query language (SQL) statements, according to an example embodiment. It may be noted that in order to explain the flowchart 200, references will be made to the elements explained in FIGS. 1 and 2.

At step 701, the method may include receiving an original NL query from a user (e.g., the end user 110 or the QA user 210). The original NL query may be fed via an interface, such as a user-facing application or device that supports natural language input. At step 702, the method may include generating a plurality of semantically equivalent NL queries based on the original NL query. Using the NL paraphrasing tool 160 or other natural language processing techniques, multiple variations of the original NL query that maintain same meaning but differ in linguistic structure are generated. The plurality of semantically equivalent NL queries ensures diversity.

At step 703, the method may include translating the original NL query and each of the semantically equivalent NL queries into corresponding NL2SQL translations using the AI-based NL2SQL translation model 170. At step 704, the method may include executes each of the NL2SQL translations to determine corresponding execution results. These execution results are derived from executing SQL commands generated from the NL2SQL translations on the database 185.

At step 705, the method may include comparing the execution results based on a distance metric, which may be followed by assessing the stability of the results. It may be noted that the flowchart 700 is explained to have above stated steps; however, those skilled in the art would appreciate that the flowchart 700 may have more/less number of steps which may enable all the above stated embodiments of the present disclosure.

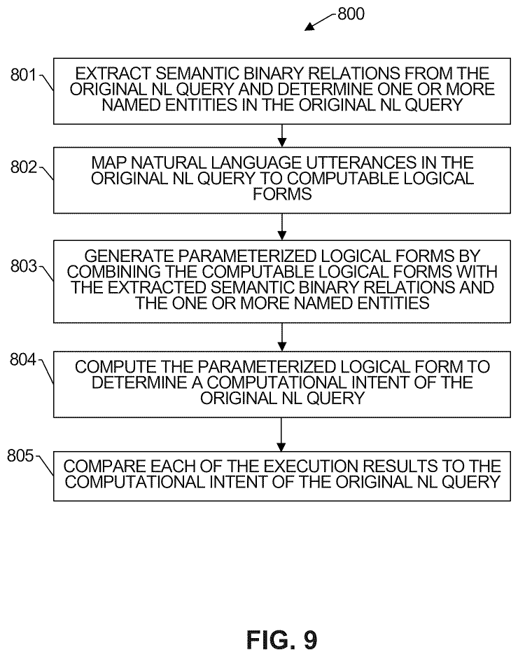

FIG. 9 illustrates a flowchart 800 of a second method for comparing execution results based on the evaluation algorithm according to an example embodiment. It may be noted that in order to explain the flowchart 800, references will be made to the elements explained in FIGS. 1 and 2.

At step 801, the second method may include extracting semantic binary relations from the original NL query and determining one or more named entities in the original NL query. The semantic binary relations may represent relationships between various elements in the original NL query, while the named entities identify significant data points such as dates, quantities, or proper nouns. At step 802, the second method may include mapping natural language utterances in the original NL query to computable logical forms. This involves translating the textual content of the NL query into formal representations (logical forms) that can be processed by the system. At step 803, the second method may include generating parameterized logical forms by combining the computable logical forms from step 802 with the extracted semantic binary relations and the one or more named entities identified in step 801.

At step 804, the second method may include computing the parameterized logical form to determine a computational intent of the original NL query. The computational intent may reflect underlying meaning and goal of the original NL query. At step 805, the second method may include comparing each of the execution results to the computational intent of the original NL query.

It may be noted that the flowchart 800 is explained to have above stated steps; however, those skilled in the art would appreciate that the flowchart 800 may have more/less number of steps which may enable all the above stated embodiments of the present disclosure.

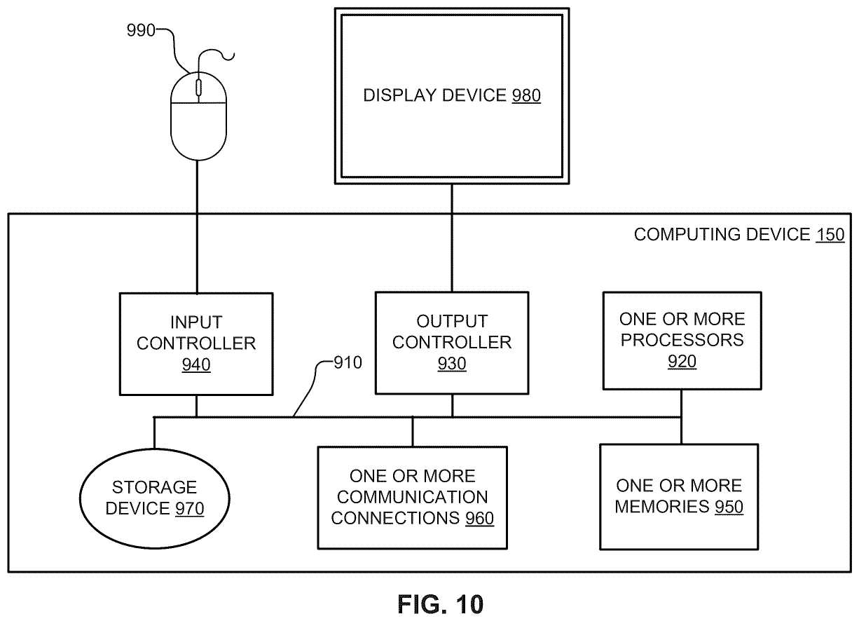

While the above-described flowcharts (e.g., FIGS. 8 and 9) outline various methods for evaluating AI responses to natural language queries and comparing execution results, it should be understood that these methods may be implemented in or involve one or more computing systems. FIG. 10 illustrates an example of a computing environment in which these methods may be executed. It will be appreciated that the computing environment is provided as an example and is not intended to suggest any limitation as to the scope of use or functionality of a described embodiment.

Referring to FIG. 10, the computing device 150 may include one or more processors 920, one or more memories 950 and a bus network 910. The bus network 910 may provide communication between the various components of the computing device 150, such as an input controller 940, an output controller 930, and one or more communication connections 960.

The one or more processors 920 may execute computer-executable instructions and can be a real or a virtual processor. In some embodiments, multiple processors may execute computer-executable instructions concurrently to increase processing power. The one or more memories 950 may include volatile memory (e.g., registers, cache, RAM), non-volatile memory (e.g., ROM, flash memory, etc.), or a combination thereof. The one or more memories 950 may store software instructions for executing the methods described in FIGS. 7, 8, and 9 when executed by one or more processors 920.

The computing device 150 may further include a storage device 970, which may be removable or non-removable. For example, the storage device 970 may include magnetic disks, solid-state drives, optical disks, or any other medium that store software instructions for implementing the methods described in FIGS. 7, 8, and 9, as well as other data generated or used during their execution. These instructions may be retrieved from the storage device 970 by the one or more processors 920 via the bus 910 and stored in the one or more memories 950, from which the processors 920 execute the instructions.

The input controller 940 may facilitate input via various input devices 990, such as a keyboard, mouse, or touchscreen. The output controller 930 may manage output to one or more output devices 980, such as a display, printer, or speakers. The one or more communication connections 960 may enable communication over wired or wireless media, connecting the computing device 150 to other entities, such as cloud servers, local databases, or networked devices.

It will be appreciated that the computing device 150 may operate in various configurations, including distributed computing environments where components such as the processing unit 920, memory 950, and storage 970 are spread across multiple physical devices. This allows the methods described in FIGS. 7 and 9 to be implemented in a wide range of environments, including standalone systems or cloud-based networks. The methods described herein may be executed using computer-readable media, which can include memory 950, storage 970, and communication media.

In some embodiments, the method of FIG. 7 (and a corresponding apparatus or system configured to perform the operations of the method) may include (or be configured to perform) additional components/modules, optional operations, and/or the components/operations described above may be modified or augmented. Some examples of modifications, optional operations and augmentations are described below. It should be appreciated that the modifications, optional operations and augmentations may each be added alone, or they may be added cumulatively in any desirable combination. In an example embodiment, the output may include an explanation for each of the execution results, in which the explanation is derived from the corresponding SQL statement used to generate respective execution result. In some cases, comparing the execution results further includes extracting semantic binary relations from the original NL query and determining one or more named entities in the original NL query. In an example embodiment, comparing the execution results may further include mapping natural language utterances in the original NL query to computable logical forms, and generating parameterized logical forms by combining the computable logical forms with the extracted semantic binary relations and the one or more named entities. In some cases, comparing the execution results further includes computing the parameterized logical form to determine a computational intent of the original NL query, comparing each of the execution results to the computational intent of the original NL query, and adjusting the list of the execution results based on an alignment level of the execution results with the computational intent of the original NL query. In some cases, determining the distance between the results may include generating a distance matrix to determine a Damerau-Levenshtein distance between the execution result of the original NL query and the execution results of the semantically equivalent NL queries.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits, or solutions to problems are described herein, it should be appreciated that such advantages, benefits, and/or solutions may be applicable to some example embodiments, but not necessarily all example embodiments. Thus, any advantages, benefits, or solutions described herein should not be thought of as being critical, required, or essential to all embodiments or to that which is claimed herein. Although specific terms are employed herein, they are used in a generic and descriptive sense only and not for purposes of limitation.

1. A method for evaluating accuracy of artificial intelligence (AI) responses to queries involving translating natural language (NL) queries into structured query language (SQL) statements, the method comprising:
receiving an original NL query from a user;
generating a plurality of semantically equivalent NL queries based on the original NL query;
translating, by an AI-based natural language to structured query language (NL2SQL) translation model, the original NL query and each of the plurality of semantically equivalent NL queries into corresponding NL2SQL translations;
executing each of the NL2SQL translations to determine corresponding execution results; and
comparing the execution results to generate a distance metric between each of the execution results of the semantically equivalent NL queries and the execution result of the original NL query.

2. The method of claim 1, further comprising:
extracting hyperparameters from the original NL query;
using the extracted hyperparameters to evaluate truthfulness of the NL2SQL translation model response; and
generating a report describing alignment of the NL2SQL translation model response to an intent of the original NL query.

3. The method of claim 2, wherein the report includes an explanation for each of the execution results, the explanation being derived from the corresponding NL2SQL translation used to generate respective execution result.

4. The method of claim 2, wherein the report includes a metric of stability of the NF2SQL translation mechanism derived from one or more of the execution results.

5. The method of claim 1, wherein comparing the execution results further comprises:
extracting semantic binary relations from the original NL query and determining one or more named entities in the original NL query.

6. The method of claim 5, wherein comparing the execution results further comprises:
mapping natural language utterances in the original NL query to computable logical forms; and
generating parameterized logical forms by combining the computable logical forms with the extracted semantic binary relations and the one or more named entities.

7. The method of claim 1, wherein a validation algorithm performs shallow semantic parsing on the original NL query to determine a computational intent of the original NL query.

8. The method of claim 1, further comprising presenting an execution result of the original NL query and execution results of the semantically equivalent NL queries to the user for analysis.

9. The method of claim 1, wherein the distance metric accounts for isomorphic transpositions in the observed results.

10. An apparatus for improving accuracy of artificial intelligence (AI) responses to queries involving translating natural language (NL) queries into structured query language (SQL) statements, the apparatus comprising:
one or more processors; and
one or more memories operatively coupled to at least one of the one or more processors and having instructions stored thereon that, when executed by at least one of the one or more processors, cause at least one of the one or more processors to:
receive an original NL query from a user;
generate a plurality of semantically equivalent NL queries based on the original NL query;
translate, by an AI based natural language to structured query language (NL2SQL) translation model, the original NL query and each of the plurality of semantically equivalent NL queries into corresponding NL2SQL translations;
execute each of the NL2SQL translations to determine corresponding execution translations;
compare the execution results to generate a distance metric between each of the execution results of the semantically equivalent NL queries and the execution result of the original NL query.

11. The apparatus of claim 10, wherein the one or more processors are further caused to:
extract hyperparameters from the original NL query;
use the extracted hyperparameters to evaluate truthfulness of the NL2SQL translation model response; and
generate a report describing alignment of the NL2SQL translation model response to the intent of the original query

12. The apparatus of claim 11, wherein the report includes an explanation for each of the execution results, the explanation being derived from the corresponding NL2SQL statement used to generate respective execution result.

13. The apparatus of claim 11, wherein the report includes a metric of stability of the NF2SQL translation mechanism derived from one or more of the execution results.

14. The apparatus of claim 10, wherein the comparison of the execution results further comprises:
extracting semantic binary relations from the original NL query and determining one or more named entities within the original NL query.

15. The apparatus of claim 14, wherein the comparison of the execution results further comprises:
mapping natural language utterances in the original NL query to computable logical forms; and
generating parameterized logical forms by combining the computable logical forms with the extracted semantic binary relations and the named entities.

16. The apparatus of claim 10, wherein a validation algorithm performs shallow semantic parsing on the original NL query to determine a computational intent of the original NL query.

17. The apparatus of claim 10, wherein the instructions stored thereon, when executed by at least one of the one or more processors, further cause at least one of the one or more processors to:
present an execution result of the original NL query and execution results of the semantically equivalent NL queries to the user for analysis.

18. The apparatus of claim 10, wherein the distance metric accounts for isomorphic transpositions in the observed results.

19. A computer program product embodied on a non-transitory computer readable medium, comprising computer code that when executed causes execution of operations including:
receiving an original natural language (NL) query from a user;
generating a plurality of semantically equivalent NL queries based on the original NL query;
translating, by an AI-based natural language to structured query language (NL2SQL) translation model, the original NL query and each of the plurality of semantically equivalent NL queries into corresponding NL2SQL translations;
executing each of the NL2SQL translations to determine corresponding execution results; and
comparing the execution results to generate a distance metric between each of the execution results of the semantically equivalent NL queries and the execution result of the original NL query.

20. The computer program product of claim 19, wherein the operations executed include:
extracting hyperparameters from the original NL query;
using the extracted hyperparameters to evaluate truthfulness of the NL2SQL translation model response; and
generating a report describing alignment of the NL2SQL translation model response to an intent of the original NL query.
